(19) United States
(12) Patent Application Publication
(10) Pub. No.: US 2002/0163601 A1
(43) Pub. Date: Nov. 7, 2002

(54) Liquid crystal display and fingerprint capture panel

(76) Inventors: Kyoung Il Min, Seoul (KR); Han Min Ryu, Sung buk Ky (KR); Kyoung Tai Lee, Seoul (KR); Dong Won Lee, Gyunggi (KR); Ho Kyun Shin, Seoul (KR)

Correspondence Address: MORRISON & FOERSTER LLP, 755 PAGE MILL RD, PALO ALTO, CA, 94304-1018, US

(21) Appl. No.: 10/014,290

(22) Filed: Dec. 10, 2001

(30) Foreign Application Priority Data
May 4, 2001 (KR) 2001-0024268

(51) Int. Cl. G02F 1/1335

(52) U.S. Cl. 349/33

(57) ABSTRACT

Disclosed herein is a liquid crystal display and fingerprint capture panel. The liquid crystal display (LCD) and fingerprint capture panel having both a data display function and a fingerprint capture function, has an LCD part and a fingerprint capture sensor arranged on the same plane. The LCD part and the fingerprint capture sensor are simultaneously arranged through the same manufacturing process. The liquid crystal display and fingerprint capture panel has a backlight commonly used for the LCD part and the fingerprint capture sensor as a light source.

### PRIORITY INFORMATION

This application claims priority under 35 U.S.C. §119 to Korean Patent Application Number 2001-0024268 filed May 4, 2001 in the Republic of Korea.

### BACKGROUND OF THE INVENTION

1. Field of the Invention

The present invention relates generally to a liquid crystal display (LCD) and fingerprint capture panel for a mobile communication terminal having fingerprint recognition functions. More particularly, this invention relates to a technology for manufacturing an LCD panel and a fingerprint capture sensor to be integrated into one body and to be horizontally arrayed in a single fabrication process.

2. Description of the Prior Art

As well known to those skilled in the art, fingerprint recognition is a kind of technology for granting an access authorization to systems such as a computer, an access control system, a banking system, etc. Fingerprint recognition systems are generally classified into two types: optic type system using a lens and a prism, and non-optic type system using a semiconductor or thin film transistor(TFT), not a lens. A TFT fingerprint capture device is a kind of contact image sensor using photosensitivity of a-Si:H, and has high photosensitivity due to its relatively thin structure. Hereinafter, the TFT fingerprint capture device is referred to as “a fingerprint capture sensor”.

The structure of the fingerprint capture sensor is shown in FIG. 1. FIG. 1 is a vertical sectional view showing a unit cell of a conventional fingerprint capture sensor. In the fingerprint capture sensor 10, referring to FIG. 1, a light sensing unit 12 and a switching unit 13 are horizontally arranged on a transparent substrate 11. Under the transparent substrate 11, a backlight irradiates light upward to be passed through the fingerprint capture sensor 10. A source electrode 12-S of the light sensing unit 12 and a drain electrode 13-D of the switching unit 13 are electrically connected to each other through a first electrode 14. A gate electrode 12-G of the light sensing unit 12 is connected to a second electrode 15.

In the above structure, a photosensitive layer 12-P such as amorphous silicon(a-Si:H) is formed between the drain electrode 12-D and source electrode 12-S of the light sensing unit 12. Then, when more than a predetermined quantity of light is received, current flows through the drain electrode 12-D and the source electrode 12-S. Accordingly, when a person who wants to be authorized touches with his finger the fingerprint capture sensor 10, light L generated from the backlight under the transparent substrate 11 is reflected on a fingerprint pattern and received by the photosensitive layer 12-P of the light sensing unit 12, thus causing electricity to flow in the light sensing unit 12.

The switching unit 13 is set to scan the fingerprint by a gate control signal applied to the gate terminal 13-G, such that the switching unit 13 is switched on per frame. Therefore, the switching unit 13 scans a fingerprint image captured in the fingerprint capture sensor 10 according to each light sensing unit 12, and generates the scanned image as a frame. An upper surface ranging from the drain electrode 13-D to the source electrode 13-S is covered with a light shielding layer 13-sh such that external light cannot be received by the switching unit 13.

Meanwhile, the fingerprint capture sensor 10 of FIG. 1 is thin and transparent, thus enabling the fingerprint sensor 10 to be attached to the LCD panel of mobile communication terminals such as mobile telephones and Personal Digital Assistants (PDA). FIG. 2a shows this method of use. Referring to FIG. 2a, a backlight 20 is installed in a displaying unit of a mobile phone, and an LCD part 22 is attached to the backlight 20. Further, a fingerprint capture sensor 24 is mounted on the LCD part 22. Referring to FIG. 2a, the data display function of an LCD is performed on the LCD part 22, the same as those of typical LCDs. Further, a fingerprint capture function is performed by the backlight, which is transmitted through LCD part 22, as an operation of FIG. 1.

FIG. 2b is a sectional view showing the layered structure of the backlight 20, the LCD part 22 and the fingerprint capture sensor 24. In FIG. 2b, the dimension of the unit cell is exaggerated for easy realization. The LCD part 22 includes a TFT panel 21 and a liquid crystal element 23, and a color filter 25 is attached to the top of the LCD part 22. In the TFT panel 21, a switching unit 27 is formed. A black matrix layer 26 is formed on a corresponding position of the color filter 25 to prevent the external light source from irradiating the switching unit 27. Finally, a TFT fingerprint capture sensor 24 is attached to the top of the layered structure. The structure of the fingerprint capture sensor 24 is the same as shown in FIG. 1.

According to the construction of FIG. 2b, the fingerprint capture function can be applied to the communication terminals such that LCD message is viewed through the fingerprint capture sensor 24. In this case, because the backlight for the LCD can be used as it is, an additional backlight for the fingerprint capture sensor 24 is not required. Additionally, as the fingerprint capture sensor 24 does not occupy any additional space, a size of a mobile communication terminal having a fingerprint recognition function may remain the same as a conventional normal mobile terminal.

However, as shown in FIGS. 2a and 2b, if the fingerprint capture sensor is attached to the LCD part in order to add the fingerprint capture function to the conventional mobile communication terminal, light from a backlight reaches the fingerprint capture sensor through the LCD part. Thus, a quantity of light transmitted out of the fingerprint capture sensor is reduced, and distribution of the light is also not uniform, such that the performance of the fingerprint capture sensor is deteriorated. Additionally, the quantity of light is more reduced due to the black matrix layer 26.

Moreover, as a message displayed on the LCD part is shown through the fingerprint capture sensor to a user, a display quality of the LCD part is deteriorated. Further, the LCD part and the fingerprint capture sensor are separately produced, and their assembly is made complicated due to an incompatibility between their own fundamental physical sizes, thus increasing the manufacturing costs of the LCD part and the fingerprint capture sensor.

### SUMMARY OF THE INVENTION

Accordingly, the present invention has been made keeping in mind the above problems occurring in the prior art, and an object of the present invention is to provide a liquid crystal display and fingerprint capture panel, which is manufactured by integrating an LCD part and a fingerprint capture sensor into one body, such that the fingerprint capture sensor is placed on one side of the same plane in which the LCD part is placed.

In order to accomplish the above object, the present invention provides a liquid crystal display and fingerprint capture panel having both a data display function and a fingerprint capture function, comprising an LCD part and a fingerprint capture sensor arranged on the same plane, the LCD part and the fingerprint capture sensor being simultaneously arranged through the same manufacturing process; and a backlight commonly used for the LCD part and the fingerprint capture sensor as a light source.

Preferably, the LCD part and the fingerprint capture sensor are arranged horizontally not vertically. At this time, an area of the fingerprint capture sensor can be a problem. In order to cover an area of a fingerprint, a sensor area more than a predetermined size is required. However, it is useless and retrogressive to install a fingerprint capture sensor with an area for covering the fingerprint area, according to a recent miniaturization trend of mobile communication terminals. Accordingly, in order to minimize an area for the fingerprint capture sensor, the fingerprint capture sensor must be operated such that it can compose image signals obtained by one-dimensional line scan method. Such an operation can be realized by current software technologies.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a sectional view showing a unit cell of a conventional TFT fingerprint capture sensor;

FIG. 2a is a perspective view showing a conventional mobile communication terminal having a fingerprint capture function;

FIG. 2b is a sectional view showing the vertical array structure of a conventional LCD panel and a fingerprint capture sensor;

FIG. 3 is a schematic perspective view showing the present invention;

FIG. 4 is a sectional view showing an LCD and fingerprint capture panel according to a preferred embodiment of the present invention;

FIG. 5 is another sectional view showing an LCD and fingerprint capture panel according to another preferred embodiment of the present invention;

FIG. 6 is a block diagram of a driving unit for the LCD and fingerprint capture panel according to a preferred embodiment of this invention; and

FIG. 7 is another block diagram of a driving unit for the LCD and fingerprint capture panel according to another preferred embodiment of this invention.

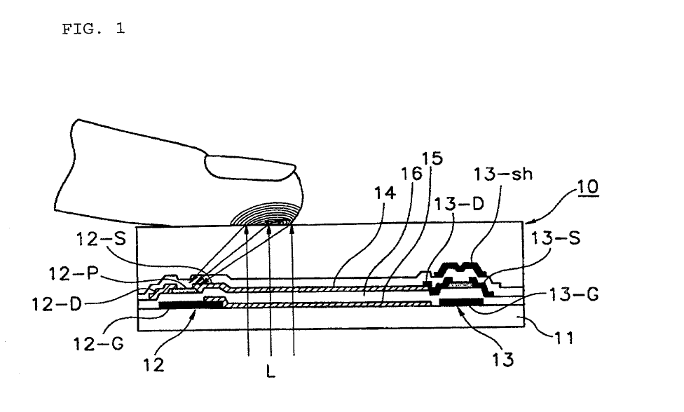

### DESCRIPTION OF THE PREFERRED EMBODIMENTS

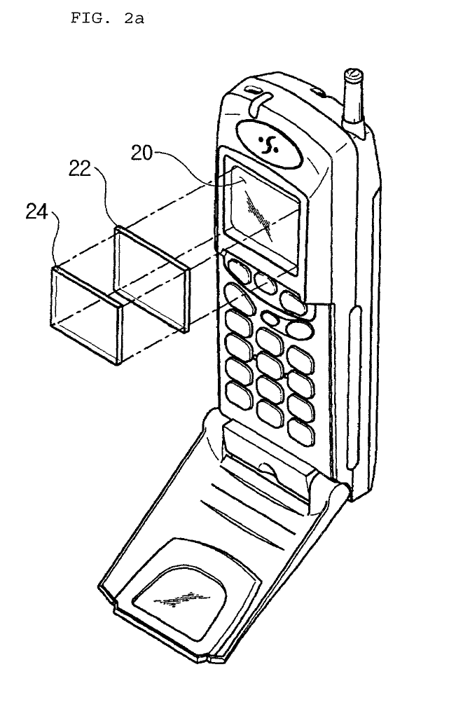

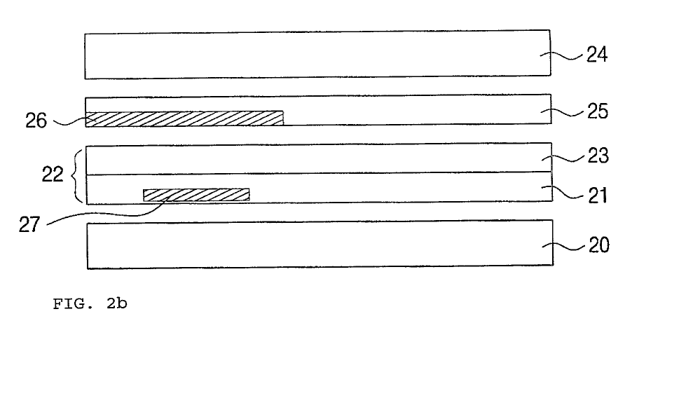

FIG. 3 is a schematic perspective view showing the present invention. Referring to FIG. 3, a fingerprint capture sensor is placed on the same plane in which a LCD part of a mobile phone is placed(a concept of the present invention is understood by comparing the mobile phone of FIG. 3 with the mobile phone of FIG. 2). Even though the fingerprint capture sensor has a small size, it is not problematic to obtain image signals by a one-dimensional line scan method. Although not specifically shown in FIG. 3, a backlight of this invention is arranged under both the LCD part and the fingerprint capture sensor, and commonly used for them.

A plane arrangement of the LCD part and the fingerprint capture sensor is simultaneously formed in the same fabrication process. The specific structures of the plane arrangement are described in detail by preferred embodiments of this invention with reference to Drawings.

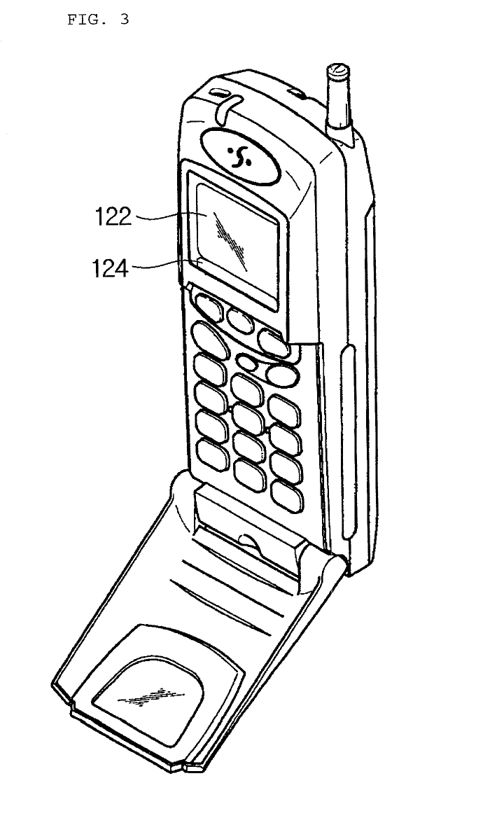

FIG. 4 is a sectional view showing a preferred embodiment for forming a fingerprint capture sensor integrated with a TFT panel 121 according to the present invention. Referring to FIG. 4, the fingerprint capture sensor is simultaneously formed on the substrate in which the TFT panel 121 is formed in the same fabrication process. In FIG. 4, the LCD panel and the fingerprint capture sensor formed in one substrate are respectively referred to as an “LCD part” and a “fingerprint capture part”.

The LCD and fingerprint capture panel comprises a backlight 120, a TFT panel 121, a liquid crystal element 123, and a color filter 125. The TFT panel 121 has an LCD part formed in a region of a substrate attached to the top of the backlight 120 and a fingerprint capture part formed in the remaining region of the substrate. The liquid crystal element 123 is attached to the top of the LCD part of the TFT panel 121. The color filter 125 is attached to the top of the liquid crystal element 123.

Further, because the fingerprint capture unit of FIG. 4 does not include the liquid crystal element 123 and the color filter 125, there is a height difference between the ultimately produced LCD unit and the fingerprint capture unit due to their different heights. Therefore, in order to level the top surfaces of the fingerprint capture part and the color filter 125, a transparent protective layer(passivation layer) 128 is preferably formed on the surface of the fingerprint capture part of the TFT panel 121. Such a construction is well known in the semiconductor manufacturing field.

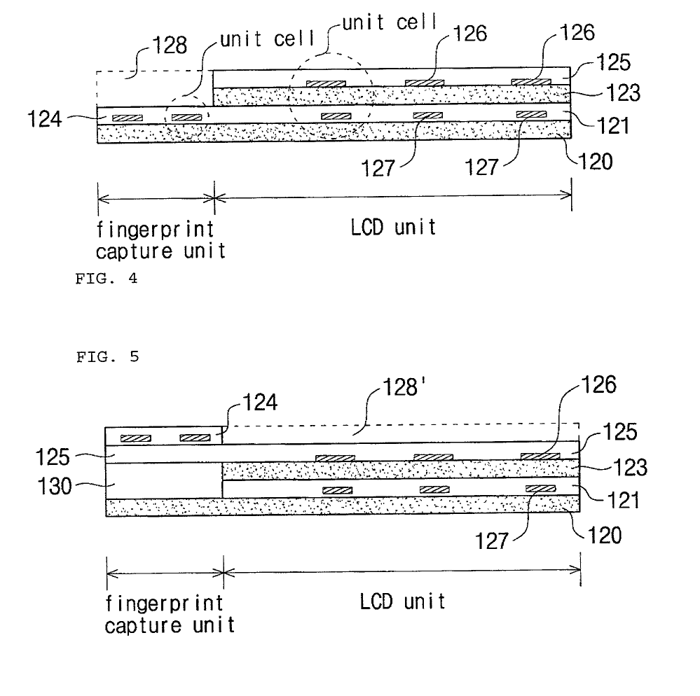

FIG. 5 is a sectional view showing another preferred embodiment for forming a fingerprint capture part on a color filter layer used as a substrate according to the present invention. Referring to FIG. 5, a LCD and fingerprint capture panel comprises a backlight 120, a TFT panel 121; a liquid crystal element 123, a color filter 125, and a fingerprint capture part. The TFT panel 121 has an LCD part formed in some region of a substrate attached to the upper part of the backlight 120. The liquid crystal element 123 is attached to the region in which the LCD part of the TFT panel 121 is formed. The color filter 125 is attached to the upper part of the liquid crystal element 123 and extended to cover the upper part of a region in which the LCD part is not formed. The fingerprint capture part is formed on a specific region of the color filter 125 covering the region in which the LCD part is not formed.

The fabrication of manufacturing the backlight 120, the TFT panel 121 and the liquid crystal element 123 are processed identically with the conventional LCD panel manufacturing fabrication. Thereafter, when a layer of the color filter 125 is produced, the fingerprint capture part is produced together with the color filter 125. Similarly to FIG. 4, preferably a surface height difference between the fingerprint capture unit and the LCD unit can be solved by leveling their surfaces by a transparent protective layer 128′.

Further, in FIG. 5, reference numeral “130” represents a region not affecting both the fingerprint capture part and the LCD part. In this case, the region 130 can be filled with the transparent protective layer as shown in FIG. 5. Alternatively, the TFT panel 121 and the liquid crystal element layer 123 can be formed on the region 130 in the fabrication process. In the former case, there is a disadvantage that a mask process is additionally required; and an advantage that a quantity of light received from the backlight to the fingerprint capture part can be somewhat increased(compared with the TFT panel 121 and the liquid crystal element 123). In the latter case, there is an advantage that fabrication processes of forming the TFT panel 121 and attaching the liquid crystal element 123 are proceeded without an additional mask process; and a disadvantage that the quantity of light from the backlight 120 to the fingerprint capture part become reduced.

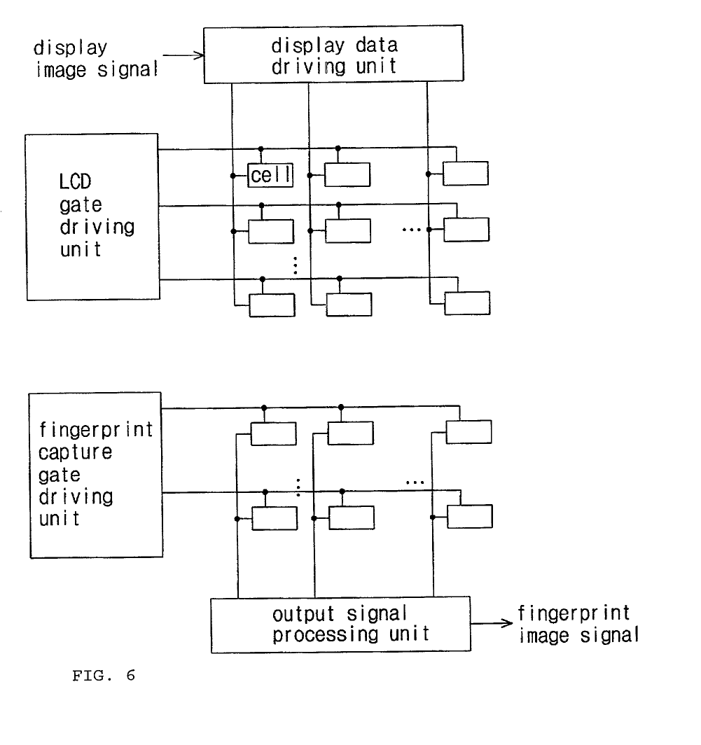

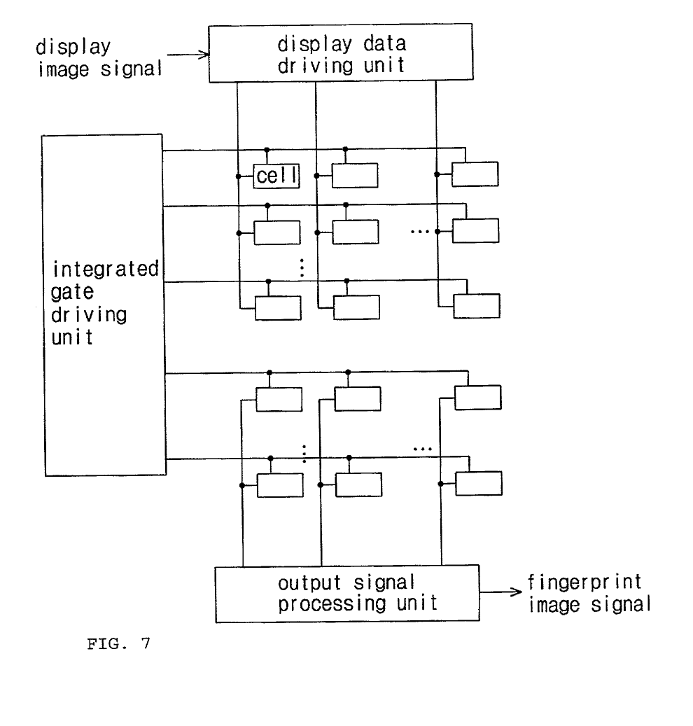

FIG. 6 is a block diagram of a driving unit for the LCD and fingerprint capture panel, which is constructed as shown in FIGS. 4 and 5. In other words, in the present invention, the LCD and fingerprint capture panel can be driven by individually adopting an LCD part driving unit and a fingerprint capture sensor driving unit. Further, as shown in FIG. 7, the LCD part driving unit and the fingerprint capture sensor driving unit can be integrated into one driving unit, thus driving the LCD and fingerprint capture panel of this invention.

As described above, the present invention provides an LCD and fingerprint capture panel, which can add a fingerprint capture function without increasing the entire size of a mobile communication terminal. Further, the present invention is advantageous in that, because light passing through the LCD part is not operated as the backlight of a fingerprint capture sensor, the LCD part can maintain an original displaying state of the LCD part and an essential fingerprint capture performance of the fingerprint capture sensor. Moreover, the present invention has advantages that both the LCD part and a fingerprint capture sensor can be manufactured in a single fabrication process without a requirement for maintaining the sizes of the LCD part and the fingerprint capture sensor to be the same, thus increasing its productivity and reducing the manufacturing costs.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A liquid crystal display (LCD) and fingerprint capture panel having both a data display function and a fingerprint capture function, comprising:
an LCD part and a fingerprint capture sensor arranged on the same plane, the LCD part and the fingerprint capture sensor being simultaneously arranged through the same manufacturing process; and
a backlight commonly used for the LCD part and the fingerprint capture sensor as a light source.

2. The LCD and fingerprint capture panel according to claim 1, wherein a region in which the fingerprint capture sensor is formed is smaller than a region in which the LCD part is formed, and the fingerprint capture sensor obtains a fingerprint image by a one-dimensional line scan method.

3. The LCD and fingerprint capture panel according to claim 1, wherein a driving unit for driving the LCD part and a driving unit for driving the fingerprint capture sensor are separated.

4. The LCD and fingerprint capture panel according to claim 1, wherein a driving unit for driving the LCD part and a driving unit for driving the fingerprint capture sensor are integrated into one driving unit.

5. A liquid crystal display(LCD) and fingerprint capture panel having both a data display function and a fingerprint capture function, comprising:
a backlight;
a thin film transistor(TFT) panel attached to a top of the backlight, the TFT panel including an LCD part formed in a region of the TFT panel and a fingerprint capture part formed in the remaining region of the TFT panel;
a liquid crystal element attached only to a top of the LCD part of the TFT panel; and
a color filter attached only to a top of the liquid crystal element.

6. The LCD and fingerprint capture panel according to claim 5, further comprising a transparent protective layer, the transparent protective layer being formed on a top of the fingerprint capture part of the TFT panel so that a top surface of the fingerprint capture part and a top surface of the color filter are level.

7. The LCD and fingerprint capture panel according to claim 5, wherein the region in which the fingerprint capture part is formed is smaller than a region in which the LCD part is formed, and the fingerprint capture part obtains a fingerprint image by a one-dimensional line scan method.

8. The LCD and fingerprint capture panel according to claim 5, wherein a driving unit for driving the LCD part and a driving unit for driving the fingerprint capture part are separated.

9. The LCD and fingerprint capture panel according to claim 5, wherein a driving unit for driving the LCD part and a driving unit for driving the fingerprint capture part are integrated into one driving unit.

10. A liquid crystal display(LCD) and fingerprint capture panel having both a data display function and a fingerprint capture function, comprising:
a backlight;
a thin film transistor(TFT) panel attached to a top of the backlight and including an LCD part formed in a region of the TFT panel;
a liquid crystal element attached to a top of the LCD part of the TFT panel;
a color filter attached to a top of the liquid crystal element and extended to cover a region in which the LCD part is not formed; and
a fingerprint capture part formed in a region of the color filter covering the region in which the LCD part is not formed.

11. The LCD and fingerprint capture panel according to claim 10, wherein a transparent protective layer is formed on a surface of the region in which the fingerprint capture part is not formed in the color filter, such that a surface of the color filter and a surface of the fingerprint capture part are leveled.

12. The LCD and fingerprint capture panel according to claim 10, wherein the region in which the fingerprint capture part is formed is smaller than the region in which the LCD part is formed, and the fingerprint capture part obtains a fingerprint image by a one-dimensional line scan method.

13. The LCD and fingerprint capture panel according to claim 10, wherein a driving unit for driving the LCD part and a driving unit for driving the fingerprint capture part are separated.

14. The LCD and fingerprint capture panel according to claim 10, wherein a driving unit for driving the LCD part and a driving unit for driving the fingerprint capture part are integrated into one driving unit.
